(19) United States
(12) Patent Application Publication
(10) Pub. No.: US 2026/0046721 A1
(43) Pub. Date: Feb. 12, 2026

(54) MOBILITY ENHANCEMENTS IN WIRELESS COMMUNICATIONS SYSTEMS

(71) Applicant: QUALCOMM Incorporated, San Diego, CA (US)

(72) Inventors: Vishnu Vardhan CHETLUR RAVI, San Diego, CA (US); Le LIU, San Jose, CA (US); Alberto RICO ALVARINO, San Diego, CA (US); Mostafa KHOSHNEVISAN, San Diego, CA (US)

(21) Appl. No.: 19/292,879

(22) Filed: Aug. 6, 2025

Related U.S. Application Data
(60) Provisional application No. 63/681,712, filed on Aug. 9, 2024.

(51) Int. Cl. H04W 36/08; H04W 76/10

(52) U.S. Cl. CPC H04W 36/08; H04W 76/10

(57) ABSTRACT

Methods, systems, and devices for method for wireless communication are described. A user equipment (UE) may establish a connection with a serving cell of a network entity, where the network entity supports a set of cells including the serving cell. In some examples, the UE may receive an indication of a common search space configuration associated with a target non-serving cell of the network entity and may also receive a control signal including an indication to perform a handover procedure. The UE may then perform the handover procedure to switch the connection from the serving cell of the network entity to the target non-serving cell of the network entity based on receiving the control signal and the common search space configuration associated with the target non-serving cell of the network entity.

### CROSS REFERENCE

The present Application for Patent claims the benefit of U.S. Provisional Patent Application No. 63/681,712 by Chetlur Ravi et al., entitled “MOBILITY ENHANCEMENTS IN WIRELESS COMMUNICATIONS SYSTEMS,” filed Aug. 9, 2024, assigned to the assignee hereof, and expressly incorporated by reference herein FIELD OF TECHNOLOGY

The following relates to method for wireless communication, including mobility enhancements in wireless communications systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include establishing a connection with a serving cell of a network entity, where the network entity supports a set of multiple cells including the serving cell, receiving an indication of a common search space configuration associated with a target non-serving cell of the network entity, receiving a control signal including an indication to perform a handover procedure, and performing a handover procedure to switch the connection from the serving cell of the network entity to the target non-serving cell of the network entity based on receiving the control signal and the common search space configuration associated with the target non-serving cell of the network entity.

A UE for wireless communications is described. The UE may include one or more memories storing processor executable code, and one or more processors coupled with the one or more memories. The one or more processors may individually or collectively be operable to execute the code to cause the UE to establish a connection with a serving cell of a network entity, where the network entity supports a set of multiple cells including the serving cell, receive an indication of a common search space configuration associated with a target non-serving cell of the network entity, receive a control signal including an indication to perform a handover procedure, and perform a handover procedure to switch the connection from the serving cell of the network entity to the target non-serving cell of the network entity based on receiving the control signal and the common search space configuration associated with the target non-serving cell of the network entity.

Another UE for wireless communications is described. The UE may include means for establishing a connection with a serving cell of a network entity, where the network entity supports a set of multiple cells including the serving cell, means for receiving an indication of a common search space configuration associated with a target non-serving cell of the network entity, means for receiving a control signal including an indication to perform a handover procedure, and means for performing a handover procedure to switch the connection from the serving cell of the network entity to the target non-serving cell of the network entity based on receiving the control signal and the common search space configuration associated with the target non-serving cell of the network entity.

A non-transitory computer-readable medium storing code for wireless communications is described. The code may include instructions executable by one or more processors to establish a connection with a serving cell of a network entity, where the network entity supports a set of multiple cells including the serving cell, receive an indication of a common search space configuration associated with a target non-serving cell of the network entity, receive a control signal including an indication to perform a handover procedure, and perform a handover procedure to switch the connection from the serving cell of the network entity to the target non-serving cell of the network entity based on receiving the control signal and the common search space configuration associated with the target non-serving cell of the network entity.

In some examples of the method, UEs, and non-transitory computer-readable medium described herein, receiving the indication may include operations, features, means, or instructions for receiving, from the target non-serving cell of the network entity, a synchronization signal block associated with the target non-serving cell of the network entity.

Some examples of the method, UEs, and non-transitory computer-readable medium described herein may further include operations, features, means, or instructions for decoding the synchronization signal block associated with the target non-serving cell of the network entity to identify at least one of a physical cell identity associated with the target non-serving cell of the network entity, a control resource set indication associated with the target non-serving cell of the network entity, a search space indication associated with the target non-serving cell of the network entity, or any combination thereof.

In some examples of the method, UEs, and non-transitory computer-readable medium described herein, receiving the indication may include operations, features, means, or instructions for receiving, from the serving cell of the network entity, a radio resource control signal including the indication of the common search space configuration associated with the target non-serving cell of the network entity.

In some examples of the method, UEs, and non-transitory computer-readable medium described herein, receiving the control signal may include operations, features, means, or instructions for receiving the control signal including an indication to switch a current common search space configuration associated with the serving cell of the network entity to the common search space configuration associated with the target non-serving cell of the network entity.

Some examples of the method, UEs, and non-transitory computer-readable medium described herein may further include operations, features, means, or instructions for switching a current UE specific search space configuration associated with the serving cell of the network entity to a UE-specific search space configuration associated with the target non-serving cell of the network entity based on receiving the control signal.

In some examples of the method, UEs, and non-transitory computer-readable medium described herein, the control signal includes a radio resource control signal or a medium access control (MAC) control element associated with transmission configuration indication activation or deactivation, or both.

In some examples of the method, UEs, and non-transitory computer-readable medium described herein, simultaneously communicating with the serving cell of the network entity and the target non-serving cell of the network entity using at least two frequency bands, where a first frequency band of the at least two frequency bands may be associated with the serving cell of the network entity and a second frequency band of the at least two frequency bands may be associated with the target non-serving cell of the network entity.

Some examples of the method, UEs, and non-transitory computer-readable medium described herein may further include operations, features, means, or instructions for receiving a control signal indication to assign the target non-serving cell as a new serving cell and the serving cell as a new non-serving cell of the network entity based on performing the handover procedure and receiving an indication to deactivate the new non-serving cell of the network entity based on one or more measurements associated with the new non-serving cell of the network entity being less than a threshold.

Some examples of the method, UEs, and non-transitory computer-readable medium described herein may further include operations, features, means, or instructions for transmitting, to the serving cell of the network entity, a measurement report associated with the target non-serving cell of the network entity, where receiving the control signal includes receiving, from the serving cell of the network entity, a beam switch indication downlink control information or a MAC control element associated with transmission configuration indication activation based on transmitting the measurement report associated with the target non-serving cell of the network entity.

Some examples of the method, UEs, and non-transitory computer-readable medium described herein may further include operations, features, means, or instructions for transmitting, to the serving cell of the network entity, an indication of a capability of the UE to support the handover procedure to switch the connection from the serving cell of the network entity to the target non-serving cell of the network entity based on a beam switch command or a transmission configuration indication state activation command, or both, where receiving the indication of the common search space may be based on the indication of the capability of the UE.

A method for wireless communications by a UE is described. The method may include establishing a connection with a first cell of a network entity, where the network entity supports a set of multiple cells including the first cell, receiving an indication to refrain from resetting control information during a handover procedure, and performing the handover procedure to switch the connection from the first cell of the network entity to a second cell of the network entity without resetting the control information based on receiving the indication.

A UE for wireless communications is described. The UE may include one or more memories storing processor executable code, and one or more processors coupled with the one or more memories. The one or more processors may individually or collectively be operable to execute the code to cause the UE to establish a connection with a first cell of a network entity, where the network entity supports a set of multiple cells including the first cell, receive an indication to refrain from resetting control information during a handover procedure, and perform the handover procedure to switch the connection from the first cell of the network entity to a second cell of the network entity without resetting the control information based on receiving the indication.

Another UE for wireless communications is described. The UE may include means for establishing a connection with a first cell of a network entity, where the network entity supports a set of multiple cells including the first cell, means for receiving an indication to refrain from resetting control information during a handover procedure, and means for performing the handover procedure to switch the connection from the first cell of the network entity to a second cell of the network entity without resetting the control information based on receiving the indication.

A non-transitory computer-readable medium storing code for wireless communications is described. The code may include instructions executable by one or more processors to establish a connection with a first cell of a network entity, where the network entity supports a set of multiple cells including the first cell, receive an indication to refrain from resetting control information during a handover procedure, and perform the handover procedure to switch the connection from the first cell of the network entity to a second cell of the network entity without resetting the control information based on receiving the indication.

Some examples of the method, UEs, and non-transitory computer-readable medium described herein may further include operations, features, means, or instructions for transmitting, to the first cell, an indication of a capability of the UE to support the handover procedure to switch the connection from the first cell of the network entity to the second cell of the network entity without resetting the control information based on receiving the indication, where receiving the indication may be based on the indication of the capability of the UE.

In some examples of the method, UEs, and non-transitory computer-readable medium described herein, the control information includes a radio resource control or a MAC, or both.

In some examples of the method, UEs, and non-transitory computer-readable medium described herein, the network entity supports the second cell. In some examples of the method, UEs, and non-transitory computer-readable medium described herein, the second cell may be supported by a second network entity.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports mobility enhancements in wireless communications systems in accordance with one or more aspects of the present disclosure.

FIG. 2 shows an example of a wireless communications system that supports mobility enhancements in wireless communications systems in accordance with one or more aspects of the present disclosure.

FIG. 3 shows an example of a process flow that supports mobility enhancements in wireless communications systems in accordance with one or more aspects of the present disclosure.

FIGS. 4 and 5 show block diagrams of devices that support mobility enhancements in wireless communications systems in accordance with one or more aspects of the present disclosure.

FIG. 6 shows a block diagram of a communications manager that supports mobility enhancements in wireless communications systems in accordance with one or more aspects of the present disclosure.

FIG. 7 shows a diagram of a system including a device that supports mobility enhancements in wireless communications systems in accordance with one or more aspects of the present disclosure.

FIGS. 8 through 11 show flowcharts illustrating methods that support mobility enhancements in wireless communications systems in accordance with one or more aspects of the present disclosure.

### DETAILED DESCRIPTION

A wireless communications system may support non-terrestrial networks. In non-terrestrial networks (e.g., wireless communications systems supporting non-terrestrial communications devices), a UE may establish an initial connection with a non-terrestrial communications device (e.g., a satellite). In some examples, a non-terrestrial communications device may be configured to provide communications coverage in a cell or in multiple cells (e.g., multiple cells served by a common satellite). A cell may be defined as a logical communication entity used for communication between a UE and the non-terrestrial communications device (e.g., over a carrier). Additionally, or alternatively, a cell may also refer to a geographic coverage area or a portion of a geographic coverage area (e.g., a sector) over which the logical communication entity operates. Such cells may be geographical areas providing communication coverage using the frequency emitted by a non-terrestrial communications device in a non-terrestrial network.

In some instances, a UE may experience a handover from communicating on a first cell (e.g., source cell) to communicating on a second cell (e.g., target cell). In some cases, the UE may be a mobile UE and may move out of a coverage area of the source cell. In some cases, the cells may be implemented by a satellite, which may move relative to the UE. In such cases, the movement of the satellite may cause the cells to move and thereby cause the cell to move out of a covering the UE. For example, the UE may receive a signal to initiate a handover process for the UE. In some cases, the Additionally, or alternatively, the UE may request for a handover process and a network entity may confirm the handover request (e.g., based on a resource availability at the target cell). In some examples, a source cell and a target cell in a non-terrestrial network may be served by a common satellite. In such cases, mobility during handover may be enhanced using inter-cell beam management techniques or lower-layer triggered mobility techniques, or both. Additionally, or alternatively, the inter-cell beam management techniques depicted herein, may be applicable to terrestrial networks.

According to one or more aspects depicted herein, a UE may perform a handover procedure to switch the connection from a serving cell of a network entity (e.g., satellite) to a target non-serving cell of the network entity based on a beam switch command or a transmission configuration indication state activation command, or both. In some cases, the UE may first establish a connection with the serving cell of the network entity and may receive an indication of a common search space configuration associated with the target non-serving cell of the network entity. The UE may further receive the beam switch command or a transmission configuration indication state activation command to perform a handover procedure. Based on receiving the beam switch command or a transmission configuration indication state activation command, the UE may perform a handover procedure to switch the connection from the serving cell of the network entity to the target non-serving cell of the network entity.

Aspects of the disclosure are initially described in the context of wireless communications systems. Aspects of the disclosure are further illustrated by and described with reference to a process flow. Aspects of the disclosure are further illustrated by and described with reference to apparatus diagrams, system diagrams, and flowcharts that relate to mobility enhancements in wireless communications systems.

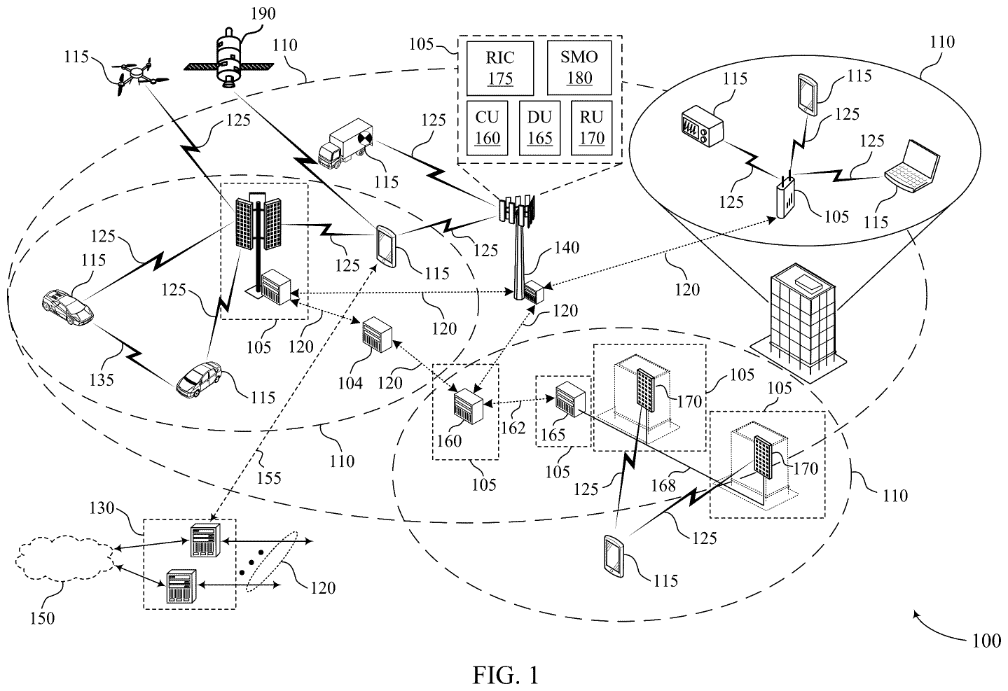

FIG. 1 shows an example of a wireless communications system 100 that supports mobility enhancements in wireless communications systems in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140). Additionally, or alternatively, the network entities 105 described herein may include or may be referred to by a person having ordinary skill in the art as a gateway, a non-terrestrial communications device (e.g., satellite) 190, or an entity including one or more of a base station, a gateway or a non-terrestrial communications device (e.g., satellite) 190.

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an Fl interface according to a protocol that defines signaling messages (e.g., an FI AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The Inter-Cell Beam Management may enable a UE 115 in coverage of a serving cell to switch to beam from a non-serving cell for reception of UE-specific data without handover. However, when the UE moves further away from the serving cell, a handover may be triggered resulting in a handover interruption time of approximately 80 ms. The PHY layer, MAC layer and RRC layer may be cell-specific and may reset after handover. In some cases, lower-layer triggered mobility may enable a serving cell to switch (executed by layer 2 signaling) to a non-serving cell. In some examples, the lower-layer triggered mobility may be based on LI measurements and reporting. In some examples, in non-terrestrial network, when a UE moves from one cell to another cell of the same satellite, the RRC layer may be common across the cells.

According to the one or more aspects of the present disclosure, to reduce handover latency in non-terrestrial networks or some terrestrial networks, a UE 115 may establish a connection with a serving cell of a network entity 105, where the network entity 105 supports a set of cells including the serving cell. In some cases, the network entity 105 may be used to describe a satellite. The UE 115 may receive an indication of a common search space configuration associated with a target non-serving cell of the network entity and may then receive a control signal including an indication to perform a handover procedure. The UE 115 may then perform the handover procedure to switch the connection from the serving cell of the network entity 105 to the target non-serving cell of the network entity 105 based on receiving the control signal and the common search space configuration associated with the target non-serving cell of the network entity 105.

Additionally, or alternatively, the UE 115 may establish a connection with a first cell of a network entity 105, where the network entity 105 supports a set of cells including the first cell. The UE 115 may receive an indication to refrain from resetting control information during a handover procedure. The UE 115 may then perform the handover procedure to switch the connection from the first cell of the network entity 105 to a second cell of the network entity 105 without resetting the control information based on receiving the indication.

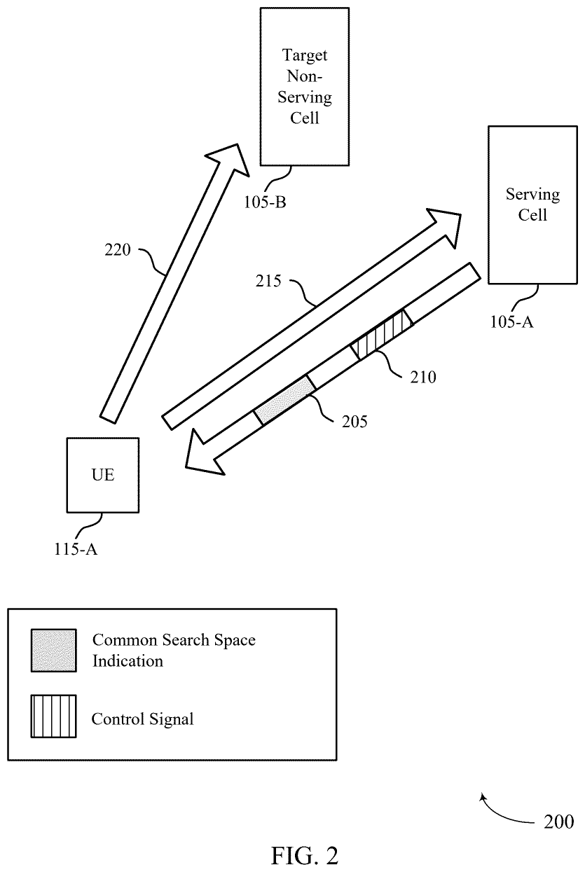

FIG. 2 shows an example of a wireless communications system 200 that supports mobility enhancements in wireless communications systems in accordance with one or more aspects of the present disclosure. The wireless communications system 200 may implement or may be implemented by aspects of the wireless communications system 100. For example, the wireless communications system 200 may include a UE 115-a, a serving cell 105-a and a target non-serving cell 105-b, which may be examples of corresponding devices described with reference to FIG. 1.

One or more aspects of the present disclosure provide for mobility enhancement based on inter-cell beam management mechanism. In particular, aspects of wireless communications system 200 support mobility from a serving cell 105-a to a target non-serving cell 105-b. The serving cell 105-a and the target non-serving cell 105-b may be implemented by a satellite, which may move relative to the UE. In some examples, a speed of the satellite may cause the UE 115-a to perform (or request for) a handover. In some examples, the UE 115-a may receive a signal to initiate a handover process for the UE 115-a or the UE 115-a may request for a handover process. To enable mobility (through common search space switching), a UE 115-a may receive a control resource set (e.g., CORESETO) and other common search space configuration of a target non-serving cell. Further, to support inter-frequency mobility, the UE 115-a may apply a carrier aggregation (CA) based approach, where the target cell becomes a secondary cell and the UE 115-a receives an indication to switch from a secondary cell to a primary cell. Additionally, or alternatively, to support inter-frequency mobility, the UE 115-a may apply a lower-layer triggered mobility-based approach. In some examples, for mobility, as a physical layer 3 (L3) is the same across two cells in non-terrestrial networks, there may not be a need for an inter-network entity coordination (over X2 interface) for handover. Accordingly, aspects depicted herein provide for mobility enhancement in accordance with the lower-layer triggered mobility mechanism. The UE 115-a and the network entities 105 may communicate without resetting MAC and RRC. This technique may further be useful in the case of non-terrestrial network. In some examples, the UE 115-a may use a UE capability parameter to indicate a capability of the UE 115-a to support inter-cell beam management based handover. The UE 115-a may further use a UE capability parameter to indicate the capability of the UE to support no MAC reset or no RRC reset or both.

As depicted herein, a UE 115-a may perform a handover from a serving cell to a target non-serving cell based on receiving a common search space configuration and a beam switch indication. The serving cell 105-a and the target non-serving cell 105-b may be served by a common satellite. The UE 115-a may establish a connection with the serving cell, where the serving cell along with a set of other cells are served by a common satellite. The UE 115-a may receive an indication 205 of a common search space configuration associated with a target non-serving cell 105-b. Further, the UE 115-a may receive a control signal 210 including an indication to perform a handover procedure. The UE 115-a may then perform the handover procedure to switch the connection from the serving cell 105-a to the target non-serving cell 105-b based on receiving the control signal 210 and the common search space (included in indication 205) associated with the target non-serving cell 105-b. The UE 115-a may be communicating with the serving cell 105-a via communication link 215. After performing the handover, the UE 115-a may communicate with the target non-serving cell 105-b (which becomes the serving cell after handover) via communication link 220.

According to one or more aspects of the present disclosure, the UE 115-a may obtain a configuration of the non-serving cell (e.g., the target non-serving cell 105-b) to support common search space switching (enabling mobility through inter-cell beam management). In some examples, the UE 115-a may be configured with a synchronization signal block of the target non-serving cell 105-b for measurement and reporting purposes. In such cases, the UE 115-a may obtain a physical cell identity information, or CORESETO, or a search space indication (e.g., search space 0) of the target non-serving cell 105-b from decoding a physical broadcast channel of the target non-serving cell 105-b. For example, the UE 115-a may receive, from the target non-serving cell 105-b, a synchronization signal block associated with the target non-serving cell 105-b. The UE 115-a may then decode the synchronization signal block associated with the target non-serving cell 105-b to identify at least one of a physical cell identity associated with the target non-serving cell 105-b, a control resource set indication associated with the target non-serving cell 105-b, a search space indication associated with the target non-serving cell 105-b, or any combination thereof.

In non-terrestrial networks, a UE 115-a may be provided with a non-terrestrial network configuration of the target non-serving cell 105-b (through system information block). In some examples, the non-terrestrial network configuration may include ephemeris data, timing advance information, and other parameters. This may be used for obtaining random access channel-less timing advance. In some examples, the serving cell 105-a may provide the UE 115-a, through unicast RRC, the different common search space (e.g., CORESETO) configurations of the target non-serving cell 105-b. For instance, the UE 115-a may receive, from the serving cell 105-a, a RRC including the indication of the common search space configuration associated with the target non-serving cell 105-b.

Additionally, or alternatively, the serving cell 105-a may also provide a configuration of a UE-specific search space prior to providing the indication 205 of the common search space beforehand. In some cases, when a transmission configuration indication activation is indicated to the UE 115-a, the UE 115-a may begin monitoring a corresponding UE-specific search space, after the application of the transmission configuration indication activation command.

In some examples, the UE 115-a may support up to a set quantity (maxNrofAdditionalPCI-r17 (INTEGER::=7)) of additional physical cell identities for beam-switching. Among these, a subset of the cells may be suitable for mobility. Aspects depicted herein support two alternatives to indicate to the UE 115-a whether to switch both the common search space and the UE-specific search space to the target non-serving cell 105-b or switch one or more UE-dedicated channels or reference signals to the target non-serving cell 105-b.

In some examples, the UE 115-a may receive the control signal 210 (e.g., RRC) including an indication to switch a current common search space configuration associated with the serving cell 105-a to the common search space configuration associated with the target non-serving cell 105-b. The UE 115-a may switch a current UE specific search space configuration associated with the serving cell 105-a to a UE-specific search space configuration associated with the target non-serving cell 105-b based on receiving the control signal 210. As described herein, the control signal may include a RRC signal or a MAC control element associated with transmission configuration indication activation or deactivation, or both.

In some examples, the control signal 210 including a beam switch command (e.g., RRC) may include an indication (e.g., flag) to switch the common search space. If the flag is set, based on reception of the beam switch command, the UE 115-a may switch its common search space along with the UE-specific search space to that of the target non-serving cell 105-b. Otherwise, the UE 115-a may maintain the common search space of the serving cell 105-a and may switch the UE-specific search space to the target non-serving cell 105-b.

In some examples, the UE 115-a may receive the indication for the UE to switch to a current common search space of the target non-serving cell 105-b through a flag in the MAC control element for transmission configuration indication activation or deactivation. In some examples, a reserve bit in the MAC control element (e.g., a reserved bit used for unified transmission configuration indication activation or deactivation) may include a flag to indicate search space switching.

In some examples, to support inter-frequency mobility, the UE 115-a may apply a CA-based approach. In the CA-based approach, the UE 115-a may apply simultaneously receive from or transmit to both the serving cell 105-a (e.g., a primary cell) and the target non-serving cell 105-b (e.g., a secondary cell) using two frequencies. For instance, the UE 115-a may simultaneously communicate with the serving cell 105-a and the target non-serving cell 105-b using at least two frequency bands. In some cases, a first frequency band of the at least two frequency bands is associated with the serving cell 105-a and a second frequency band of the at least two frequency bands is associated with the target non-serving cell 105-b. In some examples, the UE 115-a may receive a MAC control element that enable switching secondary cell to primary cell and primary cell to secondary cell. When the new secondary cell measurements are below a threshold, the UE 115-a may receive a control signal (e.g., MAC control element) deactivating the secondary cell. For example, the UE 115-a may receive a control signal indication to assign the target non-serving cell 105-b as a new serving cell and the serving cell as a new non-serving cell based on performing the handover procedure. The UE 115-a may then receive an indication to deactivate the new non-serving cell of based on one or more measurements associated with the new non-serving cell being less than a threshold.

In some examples, the UE 115-a may receive configuration information associated with the secondary cell (from sCellConfigCommon, sCellConfigDedicated, etc.). Any additional configuration corresponding to the secondary cell can be provided through a RRC transmitted from the primary cell. With the enhancement of common search space switching, as discussed herein, the UE 115-a and the network entities 105 may support inter-frequency switching with a lower-layer triggered mobility-based approach for mobility. In some cases, a network entity may transmit, to the UE, a RRC reconfiguration. Additionally, or alternatively, the UE 115-a may transmit L1 measurement report (inter-frequency) of candidate cells to the network entity. As depicted herein, the network entity may transmit beam-switch downlink control information or transmission configuration indication activation MAC control element command to the UE 115-a.

In some examples, the UE 115-a may transmit, to the serving cell 105-a, a measurement report associated with the target non-serving cell 105-b. In some cases, the UE 115-a may receive, from the serving cell 105-a, a beam switch indication downlink control information or a MAC control element associated with transmission configuration indication activation based on transmitting the measurement report associated with the target non-serving cell 105-b. In some examples, the UE 115-a may indicate whether the UE 115-a supports the inter-cell beam management based handover. For instance, the UE 115-a may transmit, to the serving cell 105-a, an indication of a capability of the UE 115-a to support the handover procedure to switch the connection from the serving cell 105-a to the target non-serving cell 105-b based on a beam switch command or a transmission configuration indication state activation command, or both. In some cases, receiving the indication of the common search space may be based on the indication of the capability of the UE 115-a. In some examples, the capability parameter may be limited to per band (in case of non-terrestrial network) or per feature per set component carrier (FSPC), if CA-based scheme is used.

According to one or more aspects of the present disclosure, the UE 115-a may receive an indication to refrain from resetting control information during a handover procedure. The UE 115-a may then perform the handover procedure to switch the connection from a first cell to a second cell without resetting the control information based on receiving the indication. Particularly, in non-terrestrial network, often, when a UE switches from one cell to another cell (intra-satellite or inter-satellite with the same network entity), there may not be a need to reset the RRC or MAC. Accordingly, the UE 115-a may receive a configuration that enables no RRC reset. In particular, the configuration may include a field ltm-RRCNoResetID indicating that the UE 115-a is to refrain from resetting RRC during a handover procedure. Additionally, or alternatively, the UE 115-a may receive a configuration that enables no MAC reset or partial MAC reset. In some examples, the configuration may include a field ltm-MACNoResetID indicating that the UE 115-a is to refrain from resetting MAC during a handover procedure. In some examples, the UE 115-a may transmit, to the first cell, an indication of a capability of the UE to support the handover procedure to switch the connection from the first cell to the second cell without resetting the control information based on receiving the indication. A UE supporting the ability to refrain from resetting control information may also indicate support of lower-layer triggered mobility-based features.

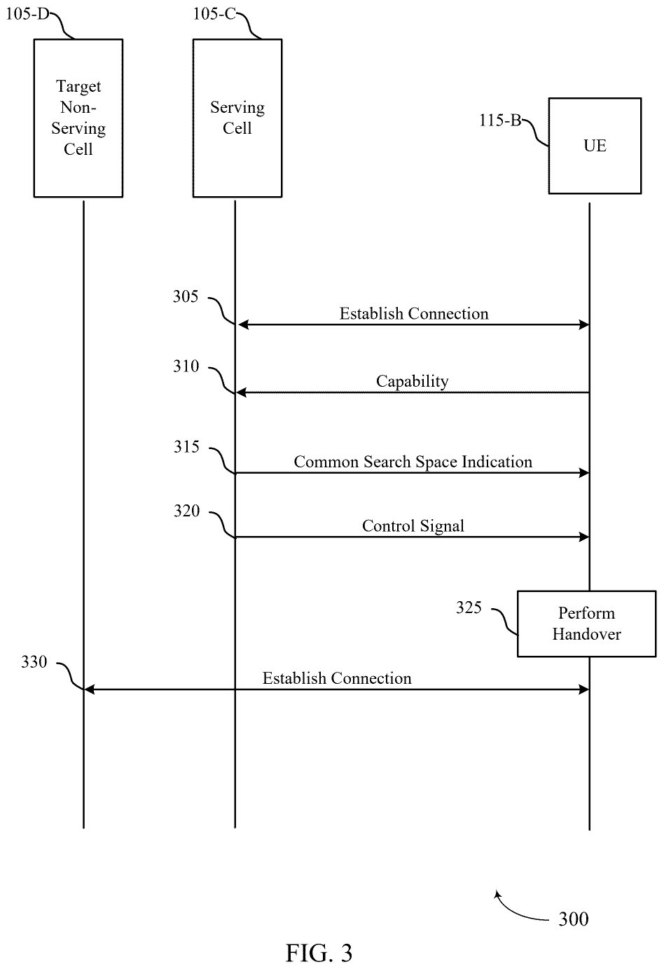

FIG. 3 shows an example of a process flow 300 that supports mobility enhancements in wireless communications systems in accordance with one or more aspects of the present disclosure. The process flow 300 includes a UE 115-b, a serving cell 105-c and a target non-serving cell 105-d, which may be examples of the corresponding devices as described with respect to FIGS. 1 and 2. In the following description of the process flow 300, the operations between the UE 115-b, the serving cell 105-c and the target non-serving cell 105-d may be performed in a different order than the example order shown. Some operations may also be omitted from the process flow 300, and other operations may be added to the process flow 300. Further, although some operations or signaling may be shown to occur at different times for discussion purposes, these operations may actually occur at the same time.

At 305, the UE 115-b may establish a connection with a serving cell 105-c of a network entity. In some examples, the network entity may support a set of cells including the serving cell 105-c. In some examples, the network entity may include a satellite in a non-terrestrial network.

At 310, the UE 115-b may transmit an indication of a capability of the UE 115-b to support the handover procedure to switch the connection from the serving cell of the network entity to a target non-serving cell 105-d of the network entity based on a beam switch command or a transmission configuration indication state activation command, or both.

At 315, the UE 115-b may receive an indication of a common search space configuration associated with the target non-serving cell of the network entity. At 320, the UE 115-b may receive a control signal including an indication to perform a handover procedure. At 325, the UE 115-b may perform a handover procedure to switch the connection from the serving cell 105-c of the network entity to the target non-serving cell 105-d of the network entity based on receiving the control signal and the common search space configuration associated with the target non-serving cell 105-d of the network entity.

At 330, the UE 115-b may establish a connection with the target non-serving cell 105-d of the network entity.

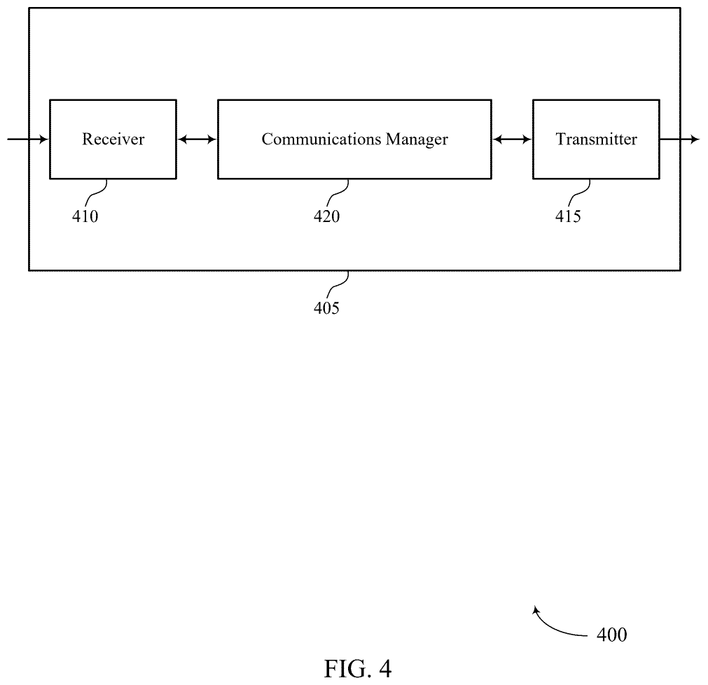

FIG. 4 shows a block diagram 400 of a device 405 that supports mobility enhancements in wireless communications systems in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to mobility enhancements in wireless communications systems). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to mobility enhancements in wireless communications systems). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of mobility enhancements in wireless communications systems as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for establishing a connection with a serving cell of a network entity, where the network entity supports a set of multiple cells including the serving cell. The communications manager 420 is capable of, configured to, or operable to support a means for receiving an indication of a common search space configuration associated with a target non-serving cell of the network entity. The communications manager 420 is capable of, configured to, or operable to support a means for receiving a control signal including an indication to perform a handover procedure. The communications manager 420 is capable of, configured to, or operable to support a means for performing the handover procedure to switch the connection from the serving cell of the network entity to the target non-serving cell of the network entity based on receiving the control signal and the common search space configuration associated with the target non-serving cell of the network entity.

Additionally, or alternatively, the communications manager 420 may support wireless communications in accordance with examples as disclosed herein. For example, the communications manager 420 is capable of, configured to, or operable to support a means for establishing a connection with a first cell of a network entity, where the network entity supports a set of multiple cells including the first cell. The communications manager 420 is capable of, configured to, or operable to support a means for receiving an indication to refrain from resetting control information during a handover procedure. The communications manager 420 is capable of, configured to, or operable to support a means for performing the handover procedure to switch the connection from the first cell of the network entity to a second cell of the network entity without resetting the control information based on receiving the indication.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, and more efficient utilization of communication resources.

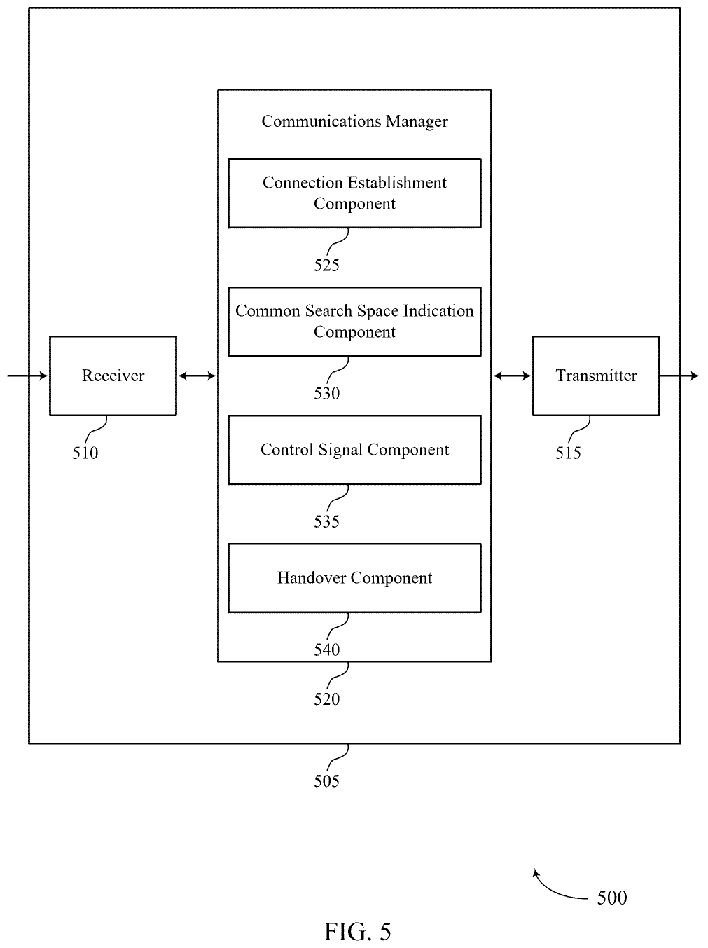

FIG. 5 shows a block diagram 500 of a device 505 that supports mobility enhancements in wireless communications systems in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to mobility enhancements in wireless communications systems). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to mobility enhancements in wireless communications systems). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of mobility enhancements in wireless communications systems as described herein. For example, the communications manager 520 may include a connection establishment component 525, a common search space indication component 530, a control signal component 535, a handover component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The connection establishment component 525 is capable of, configured to, or operable to support a means for establishing a connection with a serving cell of a network entity, where the network entity supports a set of multiple cells including the serving cell. The common search space indication component 530 is capable of, configured to, or operable to support a means for receiving an indication of a common search space configuration associated with a target non-serving cell of the network entity. The control signal component 535 is capable of, configured to, or operable to support a means for receiving a control signal including an indication to perform a handover procedure. The handover component 540 is capable of, configured to, or operable to support a means for performing the handover procedure to switch the connection from the serving cell of the network entity to the target non-serving cell of the network entity based on receiving the control signal and the common search space configuration associated with the target non-serving cell of the network entity.

Additionally, or alternatively, the communications manager 520 may support wireless communications in accordance with examples as disclosed herein. The connection establishment component 525 is capable of, configured to, or operable to support a means for establishing a connection with a first cell of a network entity, where the network entity supports a set of multiple cells including the first cell. The handover component 540 is capable of, configured to, or operable to support a means for receiving an indication to refrain from resetting control information during a handover procedure. The handover component 540 is capable of, configured to, or operable to support a means for performing the handover procedure to switch the connection from the first cell of the network entity to a second cell of the network entity without resetting the control information based on receiving the indication.

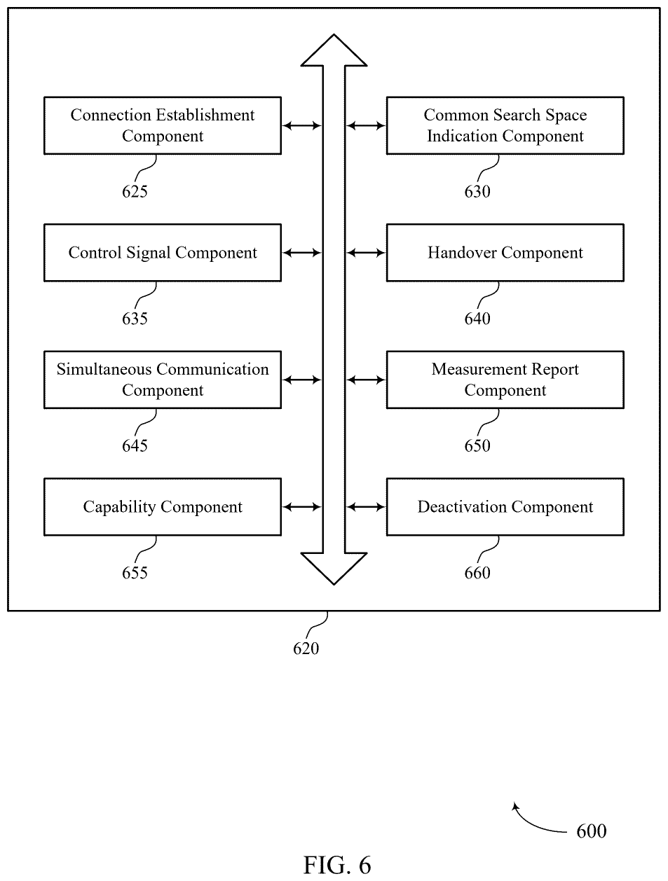

FIG. 6 shows a block diagram 600 of a communications manager 620 that supports mobility enhancements in wireless communications systems in accordance with one or more aspects of the present disclosure. The communications manager 620 may be an example of aspects of a communications manager 420, a communications manager 520, or both, as described herein. The communications manager 620, or various components thereof, may be an example of means for performing various aspects of mobility enhancements in wireless communications systems as described herein. For example, the communications manager 620 may include a connection establishment component 625, a common search space indication component 630, a control signal component 635, a handover component 640, a simultaneous communication component 645, a measurement report component 650, a capability component 655, a deactivation component 660, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The connection establishment component 625 is capable of, configured to, or operable to support a means for establishing a connection with a serving cell of a network entity, where the network entity supports a set of multiple cells including the serving cell. The common search space indication component 630 is capable of, configured to, or operable to support a means for receiving an indication of a common search space configuration associated with a target non-serving cell of the network entity. The control signal component 635 is capable of, configured to, or operable to support a means for receiving a control signal including an indication to perform a handover procedure. The handover component 640 is capable of, configured to, or operable to support a means for performing the handover procedure to switch the connection from the serving cell of the network entity to the target non-serving cell of the network entity based on receiving the control signal and the common search space configuration associated with the target non-serving cell of the network entity.

In some examples, to support receiving the indication, the common search space indication component 630 is capable of, configured to, or operable to support a means for receiving, from the target non-serving cell of the network entity, a synchronization signal block associated with the target non-serving cell of the network entity.

In some examples, the common search space indication component 630 is capable of, configured to, or operable to support a means for decoding the synchronization signal block associated with the target non-serving cell of the network entity to identify at least one of a physical cell identity associated with the target non-serving cell of the network entity, a control resource set indication associated with the target non-serving cell of the network entity, a search space indication associated with the target non-serving cell of the network entity, or any combination thereof.

In some examples, to support receiving the indication, the common search space indication component 630 is capable of, configured to, or operable to support a means for receiving, from the serving cell of the network entity, a radio resource control signal including the indication of the common search space configuration associated with the target non-serving cell of the network entity.

In some examples, to support receiving the control signal, the control signal component 635 is capable of, configured to, or operable to support a means for receiving the control signal including an indication to switch a current common search space configuration associated with the serving cell of the network entity to the common search space configuration associated with the target non-serving cell of the network entity.

In some examples, the handover component 640 is capable of, configured to, or operable to support a means for switching a current UE specific search space configuration associated with the serving cell of the network entity to a UE-specific search space configuration associated with the target non-serving cell of the network entity based on receiving the control signal.

In some examples, the control signal includes a radio resource control signal or a MAC control element associated with transmission configuration indication activation or deactivation, or both.

In some examples, the simultaneous communication component 645 is capable of, configured to, or operable to support a means for simultaneously communicating with the serving cell of the network entity and the target non-serving cell of the network entity using at least two frequency bands, where a first frequency band of the at least two frequency bands is associated with the serving cell of the network entity and a second frequency band of the at least two frequency bands is associated with the target non-serving cell of the network entity.

In some examples, the control signal component 635 is capable of, configured to, or operable to support a means for receiving a control signal indication to assign the target non-serving cell as a new serving cell and the serving cell as a new non-serving cell of the network entity based on performing the handover procedure. In some examples, the deactivation component 660 is capable of, configured to, or operable to support a means for receiving an indication to deactivate the new non-serving cell of the network entity based on one or more measurements associated with the new non-serving cell of the network entity being less than a threshold.

In some examples, the measurement report component 650 is capable of, configured to, or operable to support a means for transmitting, to the serving cell of the network entity, a measurement report associated with the target non-serving cell of the network entity, where receiving the control signal includes receiving, from the serving cell of the network entity, a beam switch indication downlink control information or a MAC control element associated with transmission configuration indication activation based on transmitting the measurement report associated with the target non-serving cell of the network entity.

In some examples, the capability component 655 is capable of, configured to, or operable to support a means for transmitting, to the serving cell of the network entity, an indication of a capability of the UE to support the handover procedure to switch the connection from the serving cell of the network entity to the target non-serving cell of the network entity based on a beam switch command or a transmission configuration indication state activation command, or both, where receiving the indication of the common search space is based on the indication of the capability of the UE.

Additionally, or alternatively, the communications manager 620 may support wireless communications in accordance with examples as disclosed herein. In some examples, the connection establishment component 625 is capable of, configured to, or operable to support a means for establishing a connection with a first cell of a network entity, where the network entity supports a set of multiple cells including the first cell. In some examples, the handover component 640 is capable of, configured to, or operable to support a means for receiving an indication to refrain from resetting control information during a handover procedure. In some examples, the handover component 640 is capable of, configured to, or operable to support a means for performing the handover procedure to switch the connection from the first cell of the network entity to a second cell of the network entity without resetting the control information based on receiving the indication.

In some examples, the capability component 655 is capable of, configured to, or operable to support a means for transmitting, to the first cell, an indication of a capability of the UE to support the handover procedure to switch the connection from the first cell of the network entity to the second cell of the network entity without resetting the control information based on receiving the indication, where receiving the indication is based on the indication of the capability of the UE.

In some examples, the control information includes a radio resource control or a MAC, or both. In some examples, the network entity supports the second cell. In some examples, the second cell is supported by a second network entity.

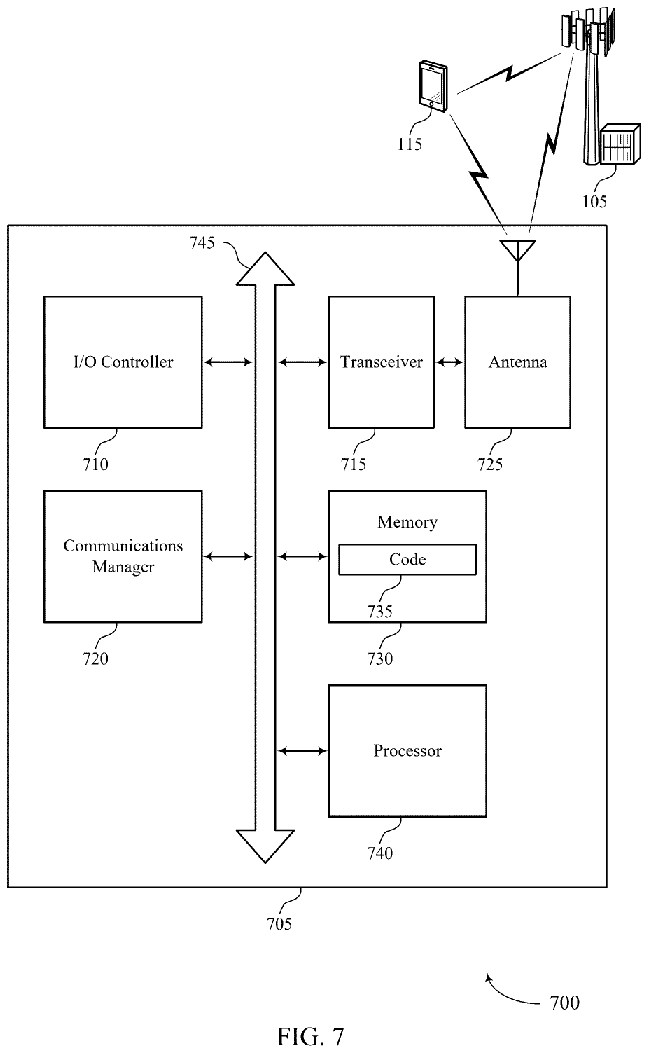

FIG. 7 shows a diagram of a system 700 including a device 705 that supports mobility enhancements in wireless communications systems in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting mobility enhancements in wireless communications systems). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for establishing a connection with a serving cell of a network entity, where the network entity supports a set of multiple cells including the serving cell. The communications manager 720 is capable of, configured to, or operable to support a means for receiving an indication of a common search space configuration associated with a target non-serving cell of the network entity. The communications manager 720 is capable of, configured to, or operable to support a means for receiving a control signal including an indication to perform a handover procedure. The communications manager 720 is capable of, configured to, or operable to support a means for performing the handover procedure to switch the connection from the serving cell of the network entity to the target non-serving cell of the network entity based on receiving the control signal and the common search space configuration associated with the target non-serving cell of the network entity.

Additionally, or alternatively, the communications manager 720 may support wireless communications in accordance with examples as disclosed herein. For example, the communications manager 720 is capable of, configured to, or operable to support a means for establishing a connection with a first cell of a network entity, where the network entity supports a set of multiple cells including the first cell. The communications manager 720 is capable of, configured to, or operable to support a means for receiving an indication to refrain from resetting control information during a handover procedure. The communications manager 720 is capable of, configured to, or operable to support a means for performing the handover procedure to switch the connection from the first cell of the network entity to a second cell of the network entity without resetting the control information based on receiving the indication.

By including or configuring the communications manager 720 in accordance with examples as described herein, the device 705 may support techniques for improved communication reliability, reduced latency, improved user experience related to reduced processing, reduced power consumption, more efficient utilization of communication resources, improved coordination between devices, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of mobility enhancements in wireless communications systems as described herein, or the at least one processor 740 and the at least one memory 730 may be otherwise configured to, individually or collectively, perform or support such operations.

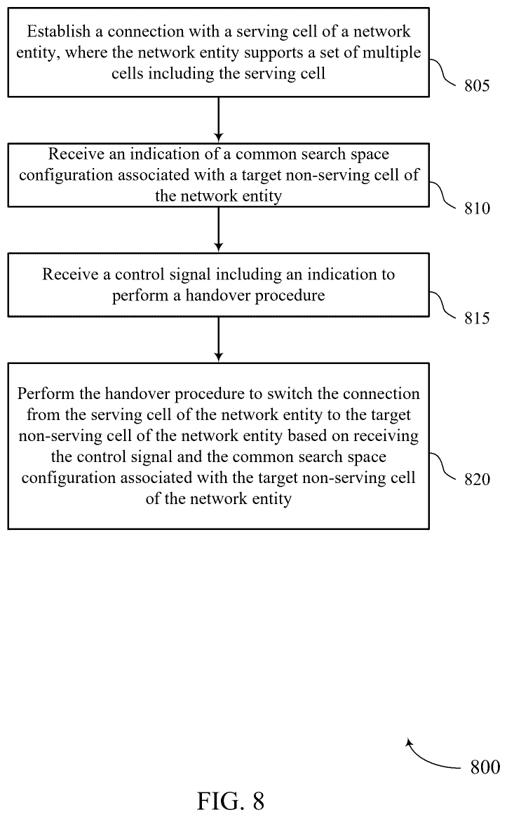

FIG. 8 shows a flowchart illustrating a method 800 that supports mobility enhancements in wireless communications systems in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include establishing a connection with a serving cell of a network entity, where the network entity supports a set of multiple cells including the serving cell. The operations of 805 may be performed in accordance with examples as disclosed herein. In some examples, aspects of the operations of 805 may be performed by a connection establishment component 625 as described with reference to FIG. 6.

At 810, the method may include receiving an indication of a common search space configuration associated with a target non-serving cell of the network entity. The operations of 810 may be performed in accordance with examples as disclosed herein. In some examples, aspects of the operations of 810 may be performed by a common search space indication component 630 as described with reference to FIG. 6.

At 815, the method may include receiving a control signal including an indication to perform a handover procedure. The operations of 815 may be performed in accordance with examples as disclosed herein. In some examples, aspects of the operations of 815 may be performed by a control signal component 635 as described with reference to FIG. 6.

At 820, the method may include performing the handover procedure to switch the connection from the serving cell of the network entity to the target non-serving cell of the network entity based on receiving the control signal and the common search space configuration associated with the target non-serving cell of the network entity. The operations of 820 may be performed in accordance with examples as disclosed herein. In some examples, aspects of the operations of 820 may be performed by a handover component 640 as described with reference to FIG. 6.

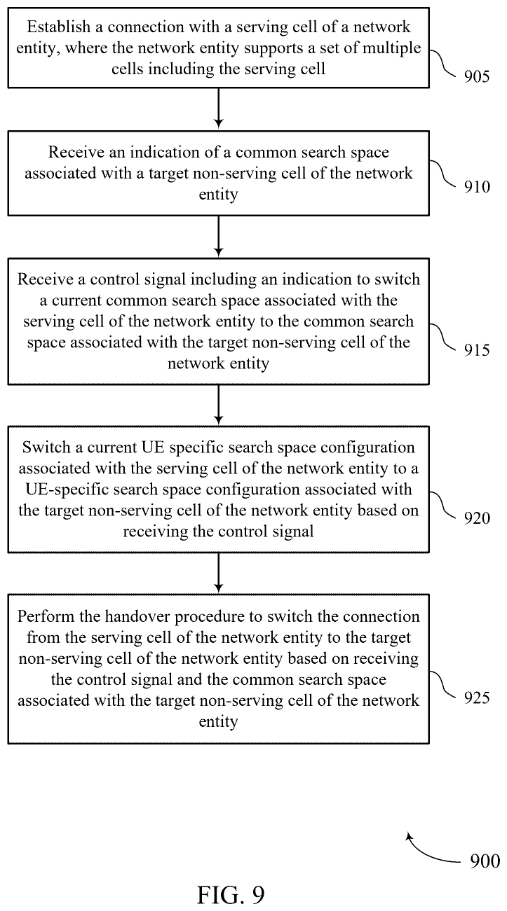

FIG. 9 shows a flowchart illustrating a method 900 that supports mobility enhancements in wireless communications systems in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include establishing a connection with a serving cell of a network entity, where the network entity supports a set of multiple cells including the serving cell. The operations of 905 may be performed in accordance with examples as disclosed herein. In some examples, aspects of the operations of 905 may be performed by a connection establishment component 625 as described with reference to FIG. 6.

At 910, the method may include receiving an indication of a common search space configuration associated with a target non-serving cell of the network entity. The operations of 910 may be performed in accordance with examples as disclosed herein. In some examples, aspects of the operations of 910 may be performed by a common search space indication component 630 as described with reference to FIG. 6.

At 915, the method may include receiving a control signal including an indication to switch a current common search space configuration associated with the serving cell of the network entity to the common search space configuration associated with the target non-serving cell of the network entity. The operations of 915 may be performed in accordance with examples as disclosed herein. In some examples, aspects of the operations of 915 may be performed by a control signal component 635 as described with reference to FIG. 6.

At 920, the method may include switching a current UE specific search space configuration associated with the serving cell of the network entity to a UE-specific search space configuration associated with the target non-serving cell of the network entity based on receiving the control signal. The operations of 920 may be performed in accordance with examples as disclosed herein. In some examples, aspects of the operations of 920 may be performed by a handover component 640 as described with reference to FIG. 6.

At 925, the method may include performing the handover procedure to switch the connection from the serving cell of the network entity to the target non-serving cell of the network entity based on receiving the control signal and the common search space configuration associated with the target non-serving cell of the network entity. The operations of 925 may be performed in accordance with examples as disclosed herein. In some examples, aspects of the operations of 925 may be performed by a handover component 640 as described with reference to FIG. 6.

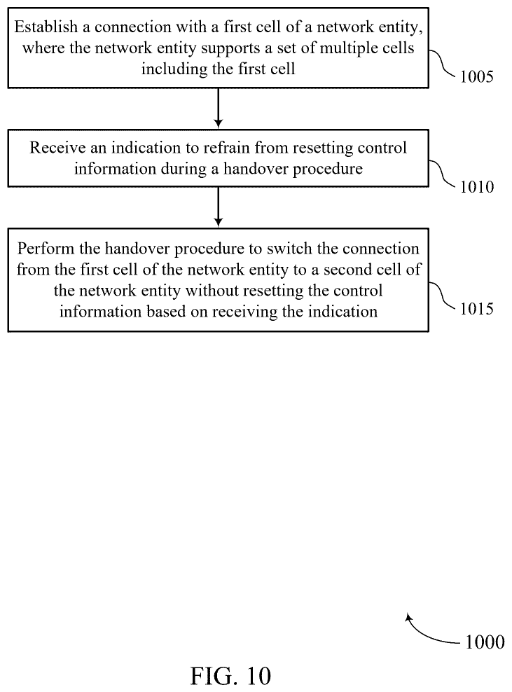

FIG. 10 shows a flowchart illustrating a method 1000 that supports mobility enhancements in wireless communications systems in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include establishing a connection with a first cell of a network entity, where the network entity supports a set of multiple cells including the first cell. The operations of 1005 may be performed in accordance with examples as disclosed herein. In some examples, aspects of the operations of 1005 may be performed by a connection establishment component 625 as described with reference to FIG. 6.

At 1010, the method may include receiving an indication to refrain from resetting control information during a handover procedure. The operations of 1010 may be performed in accordance with examples as disclosed herein. In some examples, aspects of the operations of 1010 may be performed by a handover component 640 as described with reference to FIG. 6.

At 1015, the method may include performing the handover procedure to switch the connection from the first cell of the network entity to a second cell of the network entity without resetting the control information based on receiving the indication. The operations of 1015 may be performed in accordance with examples as disclosed herein. In some examples, aspects of the operations of 1015 may be performed by a handover component 640 as described with reference to FIG. 6.

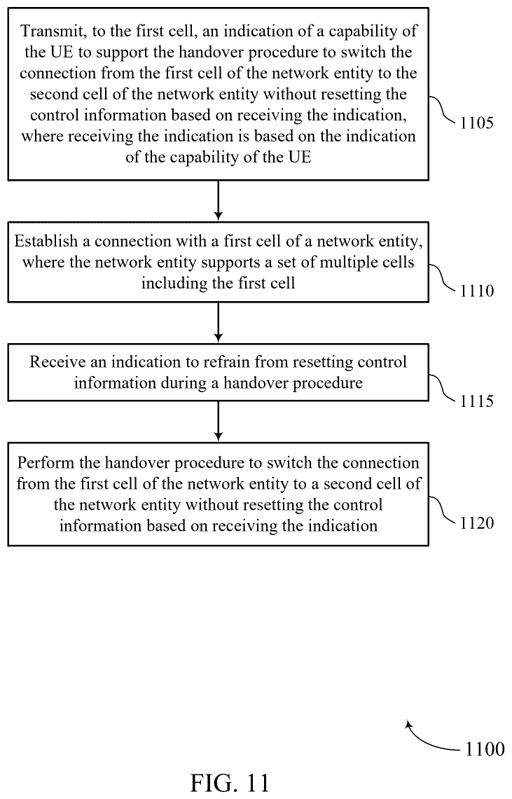

FIG. 11 shows a flowchart illustrating a method 1100 that supports mobility enhancements in wireless communications systems in accordance with one or more aspects of the present disclosure. The operations of the method 1100 may be implemented by a UE or its components as described herein. For example, the operations of the method 1100 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1105, the method may include transmitting, to the first cell, an indication of a capability of the UE to support the handover procedure to switch the connection from the first cell of the network entity to the second cell of the network entity without resetting the control information based on receiving the indication, where receiving the indication is based on the indication of the capability of the UE. The operations of 1105 may be performed in accordance with examples as disclosed herein. In some examples, aspects of the operations of 1105 may be performed by a capability component 655 as described with reference to FIG. 6.

At 1110, the method may include establishing a connection with a first cell of a network entity, where the network entity supports a set of multiple cells including the first cell. The operations of 1110 may be performed in accordance with examples as disclosed herein. In some examples, aspects of the operations of 1110 may be performed by a connection establishment component 625 as described with reference to FIG. 6.

At 1115, the method may include receiving an indication to refrain from resetting control information during a handover procedure. The operations of 1115 may be performed in accordance with examples as disclosed herein. In some examples, aspects of the operations of 1115 may be performed by a handover component 640 as described with reference to FIG. 6.

At 1120, the method may include performing the handover procedure to switch the connection from the first cell of the network entity to a second cell of the network entity without resetting the control information based on receiving the indication. The operations of 1120 may be performed in accordance with examples as disclosed herein. In some examples, aspects of the operations of 1120 may be performed by a handover component 640 as described with reference to FIG. 6.

The following provides an overview of aspects of the present disclosure:

Aspect 1: A method for wireless communications at a UE, comprising: establishing a connection with a serving cell of a network entity, wherein the network entity supports a plurality of cells including the serving cell; receiving an indication of a common search space configuration associated with a target non-serving cell of the network entity; receiving a control signal comprising an indication to perform a handover procedure; and performing a handover procedure to switch the connection from the serving cell of the network entity to the target non-serving cell of the network entity based at least in part on receiving the control signal and the common search space configuration associated with the target non-serving cell of the network entity.

Aspect 2: The method of aspect 1, wherein receiving the indication further comprises: receiving, from the target non-serving cell of the network entity, a synchronization signal block associated with the target non-serving cell of the network entity.

Aspect 3: The method of aspect 2, further comprising: decoding the synchronization signal block associated with the target non-serving cell of the network entity to identify at least one of a physical cell identity associated with the target non-serving cell of the network entity, a control resource set indication associated with the target non-serving cell of the network entity, a search space indication associated with the target non-serving cell of the network entity, or any combination thereof.

Aspect 4: The method of any of aspects 1 through 3, wherein receiving the indication further comprises: receiving, from the serving cell of the network entity, a radio resource control signal comprising the indication of the common search space configuration associated with the target non-serving cell of the network entity.

Aspect 5: The method of any of aspects 1 through 4, wherein receiving the control signal further comprises: receiving the control signal comprising an indication to switch a current common search space configuration associated with the serving cell of the network entity to the common search space configuration associated with the target non-serving cell of the network entity.

Aspect 6: The method of aspect 5, further comprising: switching a current UE specific search space configuration associated with the serving cell of the network entity to a UE-specific search space configuration associated with the target non-serving cell of the network entity based at least in part on receiving the control signal.

Aspect 7: The method of any of aspects 5 through 6, wherein the control signal comprises a radio resource control signal or a medium access control (MAC) control element associated with transmission configuration indication activation or deactivation, or both.

Aspect 8: The method of any of aspects 1 through 7, further comprising: simultaneously communicating with the serving cell of the network entity and the target non-serving cell of the network entity using at least two frequency bands, wherein a first frequency band of the at least two frequency bands is associated with the serving cell of the network entity and a second frequency band of the at least two frequency bands is associated with the target non-serving cell of the network entity.

Aspect 9: The method of aspect 8, further comprising: receiving a control signal indication to assign the target non-serving cell as a new serving cell and the serving cell as a new non-serving cell of the network entity based at least in part on performing the handover procedure; and receiving an indication to deactivate the new non-serving cell of the network entity based at least in part on one or more measurements associated with the new non-serving cell of the network entity being less than a threshold.

Aspect 10: The method of any of aspects 1 through 9, further comprising: transmitting, to the serving cell of the network entity, a measurement report associated with the target non-serving cell of the network entity, wherein receiving the control signal comprises receiving, from the serving cell of the network entity, a beam switch indication downlink control information or a medium access control (MAC) control element associated with transmission configuration indication activation based at least in part on transmitting the measurement report associated with the target non-serving cell of the network entity.

Aspect 11: The method of any of aspects 1 through 10, further comprising: transmitting, to the serving cell of the network entity, an indication of a capability of the UE to support the handover procedure to switch the connection from the serving cell of the network entity to the target non-serving cell of the network entity based at least in part on a beam switch command or a transmission configuration indication state activation command, or both, wherein receiving the indication of the common search space is based at least in part on the indication of the capability of the UE.

Aspect 12: A method for wireless communications at a UE, comprising: establishing a connection with a first cell of a network entity, wherein the network entity supports a plurality of cells including the first cell; receiving an indication to refrain from resetting control information during a handover procedure; and performing the handover procedure to switch the connection from the first cell of the network entity to a second cell of the network entity without resetting the control information based at least in part on receiving the indication.

Aspect 13: The method of aspect 12, further comprising: transmitting, to the first cell, an indication of a capability of the UE to support the handover procedure to switch the connection from the first cell of the network entity to the second cell of the network entity without resetting the control information based at least in part on receiving the indication, wherein receiving the indication is based at least in part on the indication of the capability of the UE.

Aspect 14: The method of any of aspects 12 through 13, wherein the control information comprises a radio resource control or a medium access control (MAC), or both.

Aspect 15: The method of any of aspects 12 through 14, wherein the network entity supports the second cell.

Aspect 16: The method of any of aspects 12 through 15, wherein the second cell is supported by a second network entity.

Aspect 17: A UE for wireless communications, comprising one or more memories storing processor-executable code, and one or more processors coupled with the one or more memories and individually or collectively operable to execute the code to cause the UE to perform a method of any of aspects 1 through 11.

Aspect 18: A UE for wireless communications, comprising at least one means for performing a method of any of aspects 1 through 11.

Aspect 19: A non-transitory computer-readable medium storing code for wireless communications, the code comprising instructions executable by one or more processors to perform a method of any of aspects 1 through 11.

Aspect 20: A UE for wireless communications, comprising one or more memories storing processor-executable code, and one or more processors coupled with the one or more memories and individually or collectively operable to execute the code to cause the UE to perform a method of any of aspects 12 through 16.

Aspect 21: A UE for wireless communications, comprising at least one means for performing a method of any of aspects 12 through 16.

Aspect 22: A non-transitory computer-readable medium storing code for wireless communications, the code comprising instructions executable by one or more processors to perform a method of any of aspects 12 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
establish a connection with a serving cell of a network entity, wherein the network entity supports a plurality of cells including the serving cell;
receive an indication of a common search space configuration associated with a target non-serving cell of the network entity;
receive a control signal comprising an indication to perform a handover procedure; and
perform the handover procedure to switch the connection from the serving cell of the network entity to the target non-serving cell of the network entity based at least in part on receiving the control signal and the common search space configuration associated with the target non-serving cell of the network entity.

2. The UE of claim 1, wherein, to receive the indication, the one or more processors are individually or collectively further operable to execute the code to cause the UE to:
receive, from the target non-serving cell of the network entity, a synchronization signal block associated with the target non-serving cell of the network entity.

3. The UE of claim 2, wherein the one or more processors are individually or collectively further operable to execute the code to cause the UE to:
decode the synchronization signal block associated with the target non-serving cell of the network entity to identify at least one of a physical cell identity associated with the target non-serving cell of the network entity, a control resource set indication associated with the target non-serving cell of the network entity, a search space indication associated with the target non-serving cell of the network entity, or any combination thereof.

4. The UE of claim 1, wherein, to receive the indication, the one or more processors are individually or collectively further operable to execute the code to cause the UE to:
receive, from the serving cell of the network entity, a radio resource control signal comprising the indication of the common search space configuration associated with the target non-serving cell of the network entity.

5. The UE of claim 1, wherein, to receive the control signal, the one or more processors are individually or collectively further operable to execute the code to cause the UE to:
receive the control signal comprising an indication to switch a current common search space configuration associated with the serving cell of the network entity to the common search space configuration associated with the target non-serving cell of the network entity.

6. The UE of claim 5, wherein the one or more processors are individually or collectively further operable to execute the code to cause the UE to:
switch a current UE specific search space configuration associated with the serving cell of the network entity to a UE-specific search space configuration associated with the target non-serving cell of the network entity based at least in part on receiving the control signal.

7. The UE of claim 5, wherein the control signal comprises a radio resource control signal or a medium access control (MAC) control element associated with transmission configuration indication activation or deactivation, or both.

8. The UE of claim 1, wherein the one or more processors are individually or collectively further operable to execute the code to cause the UE to:
simultaneously communicate with the serving cell of the network entity and the target non-serving cell of the network entity using at least two frequency bands, wherein a first frequency band of the at least two frequency bands is associated with the serving cell of the network entity and a second frequency band of the at least two frequency bands is associated with the target non-serving cell of the network entity.

9. The UE of claim 8, wherein the one or more processors are individually or collectively further operable to execute the code to cause the UE to:
receive a control signal indication to assign the target non-serving cell as a new serving cell and the serving cell as a new non-serving cell of the network entity based at least in part on performing the handover procedure; and
receive an indication to deactivate the new non-serving cell of the network entity based at least in part on one or more measurements associated with the new non-serving cell of the network entity being less than a threshold.

10. The UE of claim 1, wherein the one or more processors are individually or collectively further operable to execute the code to cause the UE to:
transmit, to the serving cell of the network entity, a measurement report associated with the target non-serving cell of the network entity, wherein receiving the control signal comprises receiving, from the serving cell of the network entity, a beam switch indication downlink control information or a medium access control (MAC) control element associated with transmission configuration indication activation based at least in part on transmitting the measurement report associated with the target non-serving cell of the network entity.

11. The UE of claim 1, wherein the one or more processors are individually or collectively further operable to execute the code to cause the UE to:
transmit, to the serving cell of the network entity, an indication of a capability of the UE to support the handover procedure to switch the connection from the serving cell of the network entity to the target non-serving cell of the network entity based at least in part on a beam switch command or a transmission configuration indication state activation command, or both, wherein receiving the indication of the common search space is based at least in part on the indication of the capability of the UE.

12. A user equipment (UE), comprising:
one or more memories storing processor-executable code; and
one or more processors coupled with the one or more memories and individually or collectively operable to execute the code to cause the UE to:
establish a connection with a first cell of a network entity, wherein the network entity supports a plurality of cells including the first cell;
receive an indication to refrain from resetting control information during a handover procedure; and
perform the handover procedure to switch the connection from the first cell of the network entity to a second cell of the network entity without resetting the control information based at least in part on receiving the indication.

13. The UE of claim 12, wherein the one or more processors are individually or collectively further operable to execute the code to cause the UE to:
transmit, to the first cell, an indication of a capability of the UE to support the handover procedure to switch the connection from the first cell of the network entity to the second cell of the network entity without resetting the control information based at least in part on receiving the indication, wherein receiving the indication is based at least in part on the indication of the capability of the UE.

14. The UE of claim 12, wherein the control information comprises a radio resource control or a medium access control (MAC), or both.

15. The UE of claim 12, wherein the network entity supports the second cell.

16. The UE of claim 12, wherein the second cell is supported by a second network entity.

17. A method for wireless communications at a user equipment (UE), comprising:
establishing a connection with a serving cell of a network entity, wherein the network entity supports a plurality of cells including the serving cell;
receiving an indication of a common search space configuration associated with a target non-serving cell of the network entity;
receiving a control signal comprising an indication to perform a handover procedure; and
performing the handover procedure to switch the connection from the serving cell of the network entity to the target non-serving cell of the network entity based at least in part on receiving the control signal and the common search space configuration associated with the target non-serving cell of the network entity.

18. The method of claim 17, wherein receiving the indication further comprises:
receiving, from the target non-serving cell of the network entity, a synchronization signal block associated with the target non-serving cell of the network entity.

19. The method of claim 18, further comprising:
decoding the synchronization signal block associated with the target non-serving cell of the network entity to identify at least one of a physical cell identity associated with the target non-serving cell of the network entity, a control resource set indication associated with the target non-serving cell of the network entity, a search space indication associated with the target non-serving cell of the network entity, or any combination thereof.

20. The method of claim 17, wherein receiving the indication further comprises:
receiving, from the serving cell of the network entity, a radio resource control signal comprising the indication of the common search space configuration associated with the target non-serving cell of the network entity.
